(19) United States
(12) Patent Application Publication
(10) Pub. No.: US 2020/0402047 A1
(43) Pub. Date: Dec. 24, 2020

(54) REGISTRY MAINTAINING PROCESSED USER REQUESTS

(71) Applicant: BenedorTSE LLC, Dover, DE (US)

(72) Inventor: Richard F. Carrott, Tallahassee, FL (US)

(73) Assignee: BenedorTSE LLC, Dover, DE (US)

(21) Appl. No.: 16/445,363

(22) Filed: Jun. 19, 2019

(51) Int. Cl. G06Q 20/40; H04L 29/06

(52) U.S. Cl. CPC G06Q 20/40; H04L 63/10

(57) ABSTRACT

A provider device provides an app to a user device, creates a first user-specific signature that incorporates user information and a first incremented value, and stores the first user-specific signature in a user-specific registry. The app receives request information, adds an app-sequenced incremented value to the request information to produce request data, and sends the request data to the provider device. The provider device calculates an expected incremented value. The provider device determines the validity of the request data by comparing at least the app-sequenced incremented value with the expected incremented value and processes the request information if the request data is valid. The provider device then creates an incremented user-specific signature that incorporates the user information and the app-sequenced incremented value and adds the incremented user-specific signature to the user-specific registry.

### BACKGROUND

### Field of the Invention

Systems and methods herein generally relate to providers processing user requests, and more particularly to computerized systems that utilize a registry maintaining records of processed user requests.

### Description of Related Art

Providers of services often struggle to keep track of requests that they satisfy for their users. Further, providers need to verify the identification of a user before processing user requests. For example, according to provisions of the USA Patriot Act, all Financial Institutions (“FI”) must verify the identity of individuals wishing to conduct financial transactions. The USA Patriot Act requires financial institutions to develop a Customer Identification Program (CIP) appropriate to the size and type of its business. Each financial institution must incorporate a CIP into their Bank Secrecy Act/Anti-money laundering compliance program.

Also, these financial institutions are not restricted only to depository institutions, such as banks and credit unions, but also includes any business that handles a “Covered Account.” This can include retail stores, any business that transfers funds or sells money orders, any business that issues credit, and any businesses that handle financial accounts, such as stock brokers and security dealers.

Additionally, the act of creating a fake identity to access goods or services has become a top-order threat for many American financial institutions. Identity fraud losses can make up to twenty to thirty percent of all credit write-offs. More, synthetic identity fraud is difficult to distinguish from legitimate consumer activity. Without a specific victim to confirm a crime, this type of fraud carries a low-risk, high-reward proposition for criminals that often sits unidentified in a lender's credit losses.

This “Covered Account” requirement broadens the field of institutions and activities covered under these regulations. This could make it inappropriate for cyber-transactions to even be allowed given that, in general terms, the parties to a cyber-transaction, or cyber-payment cannot be verified within the context of such a “transaction.” Rather, such an activity can be more properly labeled an “unverified commercial risk,” with legal notice that each party is aware of the risk and each party agrees to bare its risk, unless the parties agree to wave the risks.

While systems abound for tracking the processing of user's requests, many of such systems are slow, inaccurate, and/or lack sufficient security.

### SUMMARY

Various systems that perform methods herein include (among other components) a provider device and an app operatively connected to the provider device through a computerized network. With systems and methods herein, the provider device provides the app to a user device, creates a first user-specific signature that incorporates user information (associated with a user of the user device) and a first incremented value, and stores the first user-specific signature in a user-specific registry. The user-specific registry and the user-specific signature are unique to a single user associated with the user device.

During use, the app receives request information, adds an app-sequenced incremented value to the request information to produce request data, and sends the request data to the provider device over the computerized network. The app can also add app information of the app and user device hardware information of the user device to the request information when producing the request data. Further, the app can create a request-based user-specific signature that incorporates at least portions of the user information and the app-sequenced incremented value which can be added by the app to the request information when producing the request data.

With this request data, the provider device calculates an expected incremented value, determines the validity of the request data by comparing at least the app-sequenced incremented value generated by the app with the expected incremented value the provider device generates. Identically incremented sequencers are included within the app and the provider device, and such are used to calculate the app-sequenced incremented value and the expected incremented value.

The provider device processes the request information if the request data is valid. In addition to just processing the valid request, the provider device also creates an incremented user-specific signature that incorporates the user information and the app-sequenced incremented value based, and the provider device adds each incremented user-specific signature to the user-specific registry in order.

These and other features are described in, or are apparent from, the following detailed description.

### BRIEF DESCRIPTION OF THE DRAWINGS

Various exemplary systems and methods are described in detail below, with reference to the attached drawing figures, in which:

FIGS. 1-3 are flow diagrams of various methods herein;

FIG. 4 is a schematic diagram illustrating systems herein;

FIG. 5 is a schematic diagram illustrating connector devices herein; and

FIG. 6 is a schematic diagram illustrating computerized devices herein.

### DETAILED DESCRIPTION

As mentioned above, systems for tracking the processing of user's requests can be slow, inaccurate, and/or lack sufficient security. To address such issues, methods and system herein begin with the provider physically obtaining proper user identification (such as when financial institutions require users to show identification before opening, or performing transactions in, user accounts). Therefore, before an app is installed on a user device by the provider device herein, an agent of the provider organization that owns/operates the provider device physically obtains government-issued identification from a user who owns/operates (is associated) with the user device.

Specifically, for each request or transaction of a user, the methods and systems herein create a user-specific signature that incorporates at least user information, transaction information, and a unique, non-repeated, incremented value; and these methods and systems store each user-specific signature in order in a user-specific registry that is maintained only by the provider organization within the highly-secure provider device. Each user-specific registry is unique to a single user associated with a user device, and each user-specific signature is transaction specific. This makes each user-specific signature in a user-specific registry different from all other user-specific signatures in that user-specific registry (and different from all other user-specific signatures in all other user-specific registries).

By keeping the user-specific registry only within the very secure computer architecture maintained by the provider organization (the provider device) the next correct increment of the user-specific signature can only be known by the provider device. This makes it very difficult or impossible for any other device or actor (other than the provider-installed app operating on a previously approved user device) to produce the correct next incremented request data for the next request, thereby preventing or eliminating counterfeit requests. Further, the user-specific registry uniquely documents each transaction and demonstrates that the provider organization has verified the identity of the user for all transactions within each different Covered Account.

The form and substance of such a user-specific signature is a product of a methodology that uses data from the user's accounts, personal information, activity date/time, transaction account information, etc. The user-specific signature is an item created only by the provider device that both verifies the user's account activity and the user's agreement to that activity. Each user-specific signature is unique (they are encoded data of the user and user information account, etc.), which permits users and the provider to maintain various accounts for various needs (commercial, personal, retail, etc.) and allows the provider to simplify its processing with respect to each account's activity. The user-specific signature is also unique in that it allows a multitude of signatures related to a single user/account, or a multitude of accounts for the same user with special account needs (with each account being maintained separately, as needed: e.g. business; household; etc.).

With respect to the formation of the user-specific signature, the user-specific signature is generated by the financial institution using a methodology that encodes elements that can include the user's information, transaction information, time and date, transaction payment amount, and the user's agreement to the binding use of the signature.

Therefore, this disclosure describes improvements to technologies that produce electronic signatures, which increase the acceptance and ease of use of electronic signatures by altering conventional electronic signatures systems to permit existing user identification verification architectures to be incorporated, and thereby bring the convenience of traditional handwritten signatures to the world of electronic transactions.

Some electronic signatures require the signatory to obtain a non-changing digital certificate that is only issued after thorough verification of the signer's identity by a trusted third party. Digital certificates are intended to be unique to the individual and difficult to copy, making the signatory the sole holder of a private key that is used to create the electronic signature. However, individuals often do not properly follow procedures for maintaining such digital certificates, which can result in improper disclosure of their private key. Anyone obtaining another's digital certificate can create unauthorized electronic signatures, impacting the legitimacy of such electronic signature systems, which decreases public confidence in such system, and further discourages their use.

In view of such issues, systems and methods herein utilize existing historical identification verifications maintained by providers to reduce barriers that discourage the use of electronic signatures. Additionally, the systems and methods herein restrict the ability to create electronic signatures to only providers such as banks or other financial institutions (systems herein do not allow individual users to create e-signatures as conventional systems do), which avoids issues stemming from individuals not properly following procedures for securely maintaining items such digital certificates. By doing so, the systems and methods herein reduce the likelihood that e-signatures are counterfeit and this increases the confidence levels of those relying upon the validity of the electronic signatures (because such are produced only by more sophisticated institutions and not by inconsistently acting individuals). Further, the methods and systems herein use sequencers with data from the user request to make each electronic signature unique from all other electronic signatures (user-specific electronic signatures) which dramatically reduces the likelihood that such e-signatures are imitations, which increases security and user confidence levels.

More specifically, the methods and system herein allow the use of existing previous physical identity verifications for electronic signatures instead of imposing a requirement to engage a third-party verification service (that can be a barrier to electronic signatures). For example, financial institutions have traditionally maintained physical signature cards for holders of accounts. The methods and systems herein can use such historically maintained signature cards to verify the identity of signatories, without requiring newly obtained signatures, avoiding the need for in-person meetings between provider agents and users in some situations.

Further, the methods and systems herein include an app that is supplied only by the provider device to user devices only after the user's identity has been verified. Various hardware identifiers of the user devices are maintained by the provider. When a user makes a request through the provider's app, the provider uses their stored hardware identifiers of the user device, and other information stored about the app, to verify that the app and the user device are valid. If the app, user device, and next app-sequenced incremented value are valid, the provider (not the app or user) generates the user-specific signature that is maintained in the user-specific registry, which avoids issues stemming from individuals not properly following procedures for securely maintaining items (e.g., digital certificate) needed to generate electronic signatures, which again increase the confidence levels of those relying upon the validity of the electronic signatures produced by methods and systems herein.

Additionally, with such methods and systems only the provider device (not the app or user) stores the user-specific signature in the user-specific registry, which avoids errors individuals may encounter when handling electronic signatures, which can inadvertently alter and invalidate such signatures.

In other words, there are a number of barriers that reduce the popularity of electronic signatures that the methods and systems herein address. Such methods and systems permit historic identity verifications to be utilized, which reduces the number of personal meetings between institutions and their users, saving both parties time and effort. Such methods and systems restrict access to the provider's app to previously identified users and their devices, and verify each request made through the provider's app independently of the user device to validate the request; and, once a request is known to be valid, the provider generates and saves the user-specific signature.

Stated differently, conventional electronic signatures suffer from the problems of not being secure enough, reducing confidence in such electronic signatures or (if they do have strong security) of being overly technically complex to create and use, which also decreases popularity of conventional electronic signatures. Such technological problems place barriers in the way of using electronic signatures by reducing confidence that the electronic signature is valid (caused by the problem of low security electronic signatures) or making it very difficult to create higher security electronic signatures (caused by the problem of over-complexity of higher security electronic signatures).

Methods and systems herein solve these problems by reducing the technical complexity of creating and using high-security electronic signatures. Specifically, the methods and systems herein reduce technological complexity by limiting user interaction to a simple request through an app, with the electronic signature being generated, processed, and stored only by the provider (after verifying that the app, the user device, and the next incremented value are valid). By changing the technology to create and process electronic signatures at the provider computerized system, and by providing technology in the provider app that limits the user to making requests through the app, the revised technology of the methods and systems disclosed herein simplifies the creation of the electronic signature for the user (reducing barriers to electronic signature creation) yet still output a high-security electronic signature (reducing barriers to acceptance of electronic signatures).

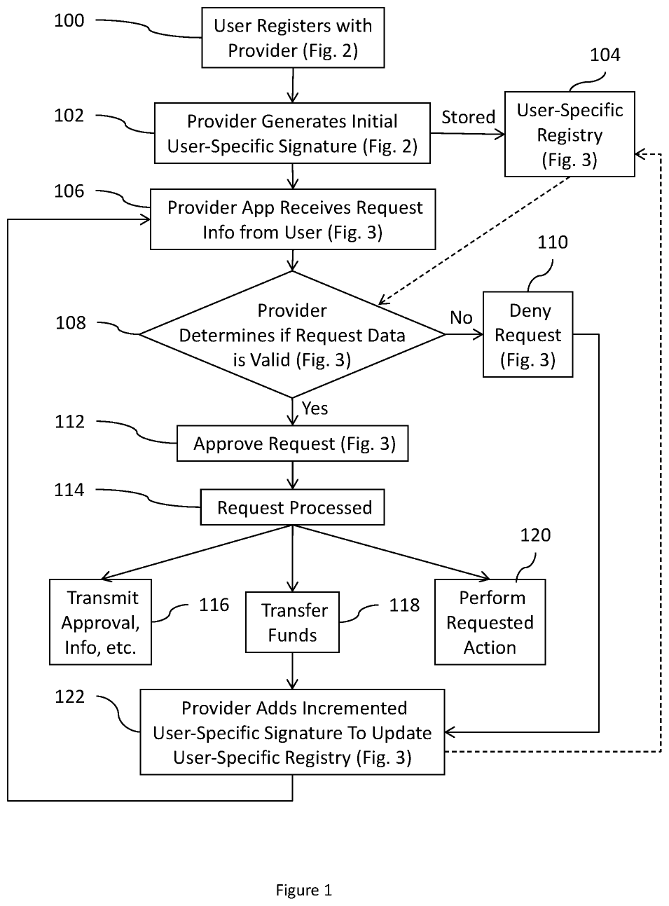

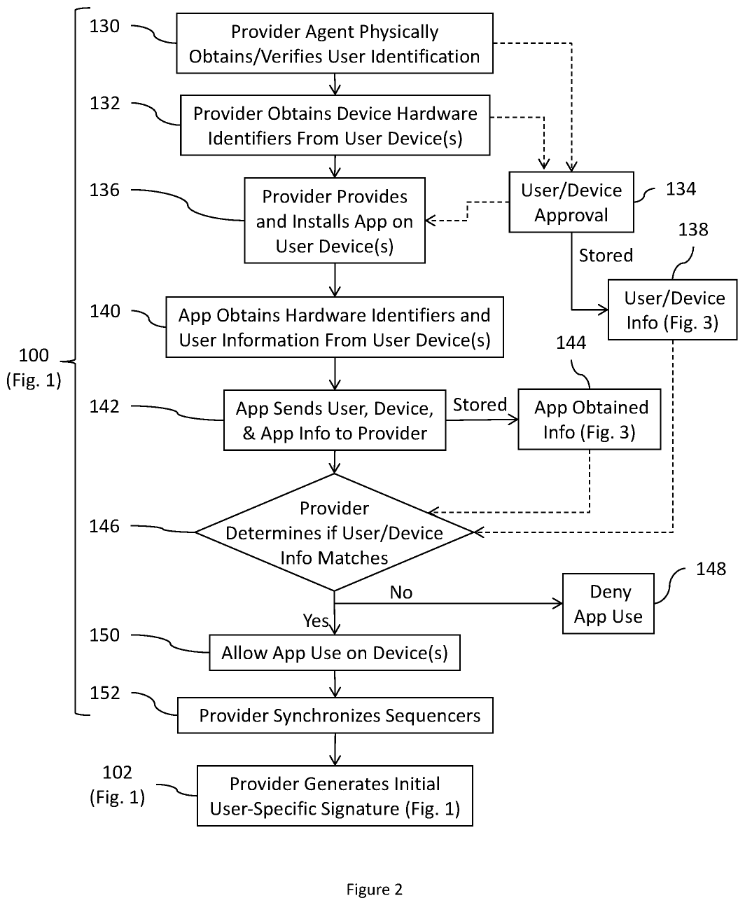

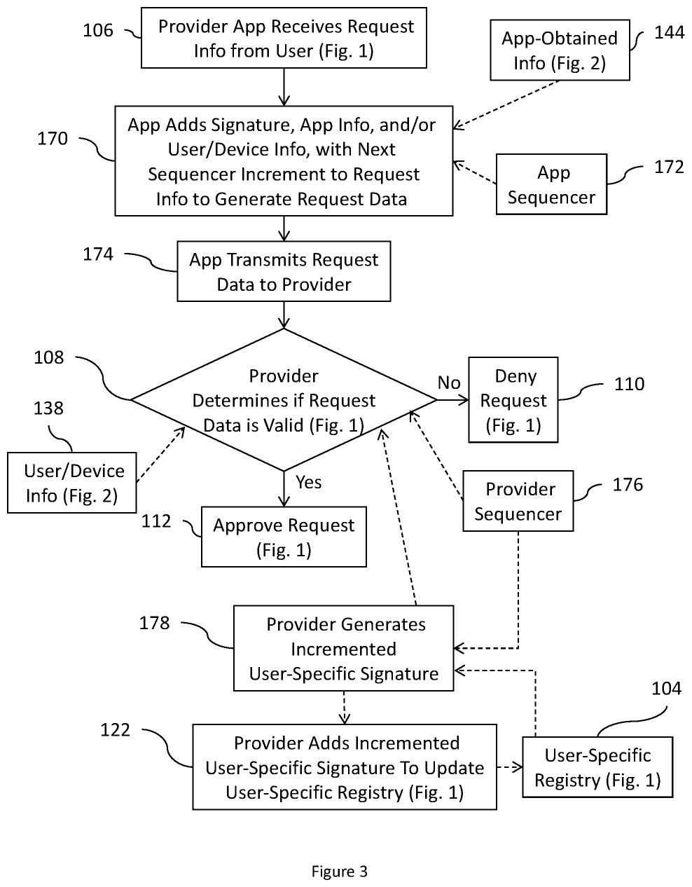

In greater detail, FIG. 1 is a flowchart illustrating aspects of exemplary methods herein. As shown in FIG. 1, with these methods a user device registers with a provider device in item 100. The registration of a user is shown in greater detail in items 130-154 in FIG. 2 that are discussed below.

Further, as shown in item 102, the provider device automatically creates an initial or first user-specific signature by combining at least portions of the user information and a first incremented value into a string of alpha-numeric characters (using, for example, an algorithm or combination process) that make up the first user-specific signature. As shown in FIG. 1, with methods herein the provider device automatically stores the first user-specific signature in a user-specific registry 104 that is maintained only in storage of the provider device (detailed in FIG. 3, discussed below). The user-specific registry 104 and the user-specific signature produced in item 102 are unique to a single user associated with the user device (e.g., the user owns, operates, and/or physically maintains the user device). Herein, a different user-specific registry is maintained for each different user and/or user device registered with the provider device.

When a user wants a provider organization that operates the provider device to take some action or grant access to an asset, the user makes what is referred to herein as a request of the provider. For example, the user request can be a request to withdraw funds from a financial institution, a request to pay a merchant for a good or service, a request for access to a restricted asset (such as information, a physical space, a virtual space, a data storage, etc.), a request to execute a document, such as a legal document, etc., or for the provider organization to take any action it is capable of performing for users.

With methods herein the provider app operating on the user device is used by the user to supply their request to the provider device (and thereby to the provider organization). Therefore, as shown in item 106, the provider app will periodically receive what is referred to herein as “request information” that is associated with various requests of the user (detailed in FIG. 3, discussed below). As shown in item 108, the provider device automatically determines the validity of the request data by comparing at least an app-sequenced incremented value with an expected incremented value, potentially using information from the user specific registry 104 as discussed in greater detail below in FIG. 3. Note that in the accompanying drawings data and information flows and transfers are shown using broken-line arrows to distinguish such from process flows, which are shown using solid-line arrows.

As shown in FIG. 1, if the request of the user is determined to not be valid in item 108, in item 110 the methods herein deny the request in item 110. However, if (based on) the request data is valid in item 108, these methods automatically output (by the provider device) approval of the request of the user in item 112. More detailed processing operations surrounding items 106 and 110 are detailed in FIG. 3 that is discussed below.

Such approval of the request of the user in item 112 causes the request to be processed in item 114. Specifically, the processing of the request can cause a number of processes to occur automatically only some examples of which are shown in FIG. 1, including: transmitting the approval to another party, granting access to a resource or information, etc. (116); transferring money to a merchant, depositing money, transferring funds between bank accounts (if, for example, the provider is a financial institution), etc. (118); performing a requested action that the provider is capable of performing (120); etc.

Whether the request is denied 110 or approved 112, with methods herein the provider device automatically creates an incremented user-specific signature (see FIG. 3, discussed below). The incremented user-specific signature is different from the initial user-specific signature in that the incremented user-specific signature incorporates the app-sequenced incremented value in addition to all information contained within the initial user-specific signature. With such, as shown by an arrow in FIG. 1, the provider device automatically adds the incremented user-specific signature created in item 122 to the user-specific registry 104. Note, as shown by the arrow flowing from item 110 to item 122 in FIG. 1, incremented user-specific signatures can include approved and denied requests, permitting the user-specific registry 104 to preserve a full, chronological record of how all requests were processed.

Specifically, the incremented user-specific signature is placed in the user-specific registry 104 immediately following the last user-specific signature in the user-specific registry 104. Therefore, the incremented user-specific signatures are stored in the user-specific registry 104 in the order in which they were created, which results in the incremented user-specific signatures being in a chronological, numerical, date/time order within the user-specific registry 104.

As noted above, some of the processing performed in item 130 in FIG. 1 is show in items 130-154 in FIG. 2, and such processing is discussed here. When registering a user device 100 in FIG. 1, a provider agent associated with the provider device (both of which are owned, controlled, or operated by the provider organization) can physically verify the identity of the user of the user device in item 130. For example, this verification 130 is, or was previously, performed by a human representative of a provider obtaining a government issued identification and a signature from the user when physically meeting with the user. For example, a bank (provider) employee can check (or have previously checked) the driver's license, passport, etc., of a new or existing user (user) and have the user provide an authorized signature (or such could have been done historically and maintained by the bank in a repository of physical signature cards). In other alternatives, a video conference with a human agent of the provider, or other virtual interface with the user (potentially with an avatar (computer generated) agent of the provider) can be used to obtain the physically supplied user information to verify the identity of the user.

Either at the same time that the user's identity is verified or at a later time, in item 132 the provider obtains what is referred to herein as “initially obtained” hardware identifiers of a user device (or multiple devices) that is supplied by the user to the provider. For example, in one option in item 132, the human representative (when physically or virtually meeting with the user) can physically connect a computerized provider device to the one or more user-supplied devices. In other examples, the provider can connect to the user device(s) remotely through a network connection to read the initially obtained hardware identifiers, or the initially obtained hardware identifiers can be obtained by the provider application during the installation of the provider's application on the user device, which occurs later (item 136) in the process flow shown in FIG. 2.

The various hardware identifiers referred to in this disclosure include identifiers of hardware components within the user device(s) including serial numbers, manufacturer's and/or brand names, model numbers, device types, device characteristics, etc., from different hardware components such as hard drive(s), processor(s), screen(s), speaker(s), battery(ies), etc., and different software components including operating system version numbers, software present, on the device, etc.

In item 134, potentially before the provider application is supplied to the user device, the provider can evaluate the initially obtained hardware identifiers to approve or disapprove the user device(s). This device approval evaluation 134 can include a determination as to whether the provider's software application (or app, for short) will properly operate on the device, whether there are any unacceptable viruses on the device, etc. Further, the evaluation can look at the combination of hardware components within the device to determine if the device is genuine as manufactured using, for example, industry-supplied serial number ranges, model number ranges, device characteristics, etc., for brand-specific component hardware, that was known to be used in valid devices as they were manufactured.

After verifying the identity of the user in item 130 (and potentially after approving the device in item 134) with these methods the provider physically supplies the provider's app to the device in item 136. The processing in item 136 can be accomplished in a number of ways. For example, if the provider's equipment was used to previously read the initially obtained hardware identifiers, that same provider equipment can supply the provider's app (while still physically connected to the device). During such processing the provider agent may be required to enter a password or key (only maintained within the provider organization) on the user device to allow the provider app to be installed on the user device. In other alternatives, the provider's app can be supplied to the device in item 136 by the provider agent physically supplying an electronic storage media device (e.g., disk, memory stick, etc.) to the user to allow the user to transfer the provider's app to the device, or the app can be remotely downloaded to the user device(s) through the network, etc. One feature of methods and systems herein is that the distribution of the provider's app in item 136 is physically restricted to users whose identity has been physically verified in item 130 by a provider agent and who have physically supplied approved devices in item 134 to a provider agent.

Also, the provider application is installed on the user device in item 136 (such app installation is typically handled by an automated installation program which varies from platform to platform). During such installation, the initially obtained hardware identifiers can be obtained from the user device, if they have not been previously obtained in item 132. If the initially obtained hardware identifiers are obtained during installation by the provider application, the initially obtained hardware identifiers are transmitted by the provider application to the provider and the same processing shown in item 134 is performed so that the provider approves or disapproves the user device. If the device is approved, installation continues; however, if the device is disapproved, installation terminates, and the provider application can be automatically deleted from the user device. Therefore, again, distribution of the provider's app is physically restricted to users whose who have physically supplied approved devices.

Further, each version of the provider's app supplied to different devices or users in item 136 is unique to each device by having a unique app identifier, unique app serial number, unique time/date stamp, and/or each unique encryption key, etc., so that each app version is unique to a specifically identified device. In a simplified example, each app can have a unique serial number that is associated with a specific user device (which can be identified by owner name, brand, model number, serial number, etc.). Further, in item 136, the provider records which device received which app to associate a specific app with each different device to which the app was supplied.

The user, hardware, and app information are maintained by the provider and stored as user/device info 138 in a secure electronic storage device of the provider device. After the provider's app has been installed on the device (the processing in item 136), as an additional safeguard the app obtains what is referred to herein as “read hardware identifiers” of the device in item 140 by the app independently reading the same hardware identifiers of the device discussed above in item 132 (including serial numbers, manufacturer's and/or brand names, model numbers, device types, device characteristics, etc., from different hardware components such as hard drive(s), processor(s), screen(s), speaker(s), battery(ies), etc., and different software components including operating system version numbers, software present, on the device, etc.). Further, in item 140, the provider's app also obtains what is referred to herein as “entered user information” by asking the user to respond to questions through a user interface of the device to resupply some or all of the same data as the physically supplied user information obtained in item 130.

The provider app encrypts and stores the read hardware identifiers and the entered user information obtained in item 142 (along with a unique app identifier) as encrypted data in electronic memory of the device. The provider app then transmits the encrypted data to the provider (e.g., a verification server) through a computer network in item 142, which the provider device stores as app-obtained info 144 in a secure electronic storage device maintained by the provider device. To prevent inappropriate or unauthorized use of the app, in item 146, with these methods the provider evaluates the encrypted data and allows 150 or denies 148 use of the app on the device. If use of the app is denied, in item 148, the app is automatically deleted from the user device. For example, in item 146 the provider can decrypt the encrypted data using a key consistent with the encryption method and key used by the app to perform the encryption. Then, in the processing in item 146 the provider app determines whether the read hardware identifiers, entered user information, and/or unique app identifier in the app-obtained information 144 match the initially obtained hardware identifiers, entered user information, and/or unique app identifier in the user/device information 138. This prevents inappropriate use of the provider app on a different user device, prevents inappropriate use of an altered provider app, etc.

The app and the provider device maintain identically incremented sequencers that are used to independently calculate increments to check values that are also independently maintained by the app and provider device. For example, the app uses its sequencer to calculate what is referred to herein as a “app-sequenced incremented value” and the provider device uses its sequencer to calculate what is referred to herein as an “expected incremented value,” both of which are explained below. Therefore, if use of the app on the device is allowed by the provider in item 150, the provider and the app can synchronize their individual sequencers in item 152, if needed.

FIG. 3 illustrates additional processing that can be performed between and around processing steps 106, 108, 110, 112, 122, etc., shown in FIG. 1, using information generated in processing in FIGS. 1 and 2 including items 104, 138, 144, etc. Therefore, the first processing shown in FIG. 3 is item 106, discussed above, where the provider app periodically receives request information from the user.

After receiving the request information from the user in item 106, the app can combine a number of items to generate what is referred to herein as “request data” in item 170 (using, for example, algorithms, combination processing, etc.). For example, the app can access the previously discussed app-obtained information 144 and the app-sequenced incremented value from the app sequencer 172, as well as information from the request information received in item 106. Therefore, in item 170, these methods and systems add or combine various pieces of data/information including, for example, the app information, the user information, the device information, etc. This information is added to, or combined with, the app-sequenced incremented value and the request information in item 170. This data can be combined in many different ways in item 170 to produce the request data including (but not limited to) combining such items into a data string (separated by commas), supplying such items to an encryption process as different variables, supplying such items into a matrix, etc., to produce, for example, a data file, flat file, array, index, table, etc.

In some options, in item 170 the app can automatically create a request-based user-specific signature (that is distinct from the user-specific signature discussed elsewhere in this disclosure) that incorporates at least portions of the user information and the app-sequenced incremented value. The app in such options can automatically add this request-based user-specific signature to the request information when producing the request data in item 170. In item 174 the app (operating on the user device) automatically sends the request data to the provider device over a computerized network.

As noted above, in item 108, the provider device automatically determines the validity of the request data and FIG. 3 shows such processing in greater detail. As shown in FIG. 3, a provider sequencer 176 of the provider device can automatically generate an expected incremented value that is supplied to the decision-making process of item 108. Also, the user/device information 138, generated as described above in the discussion of FIG. 2, is also supplied to the decision-making process of item 108.

Further, when determining the validity of the request data in item 108, as shown in FIG. 3, the provider device automatically calculates an expected incremented value. In one example, a provider sequencer 176 can simply produce the expected incremented value, or the expected incremented value can be calculated by adding an increment amount (potentially constant or potentially generated by the provider sequencer 176) to the first incremented value of the first user-specific signature within the user-specific registry, or to the incremented value within the most recently stored incremented user-specific signature within the user-specific registry, if incremented user-specific signatures are present in the user-specific registry.

As noted above, and the previous user-specific signature is the most recently entered or last entered user-specific signature within the user-specific registry 104. For the very first request, the only item that will be in the user-specific registry is the initial user-specific signature that is used to create the user-specific registry 104 in item 102 shown in FIG. 1 and the initial user-specific signature will be the very first “previous” user-specific signature. As explained above in item 122 in FIG. 1, for each subsequent request, the incremented user-specific signature is placed in the user-specific registry 104 immediately following the last user-specific signature in the user-specific registry 104. Therefore, the most immediately previous user-specific signature will be at the very end (very bottom, very last entry, most recent entry) of the user-specific registry 104.

Regarding the sequencers, as noted above, the app sequencer 172 and the provider sequencer 176 are identical in increment and each performs a single increment for each different receipt of request information 106. The increment amount can be the same for each increment or can vary (change, be different) between each increment; however, the app sequencer 172 and the provider sequencer 176 vary the increment amount identically if varying the increment amount. With regard to terminology, an increment amount is added to a previous value to produce the incremented value; where, for example, if an increment amount were 3 were used to increment a previous incremented value of 12, the next incremented value would be 15.

In one example, both the app sequencer 172 and the provider sequencer 176 can produce identical incremented values. In other examples, the app sequencer 172 can produce the app-sequenced incremented value, while the provider sequencer 176 produces an increment amount that is applied to incremented value within the most recent incremented user-specific signature in the user-specific registry 104 to generate the expected incremented value.

As also shown in item 152 in FIG. 2, the app sequencer 172 and the provider sequencer 176 can be synchronized during the process of installing and initializing the app on user device. Because these synchronizers are identical in increment and can be initially synchronized, for each different receipt of request information 106 these synchronizers increment the same value by the same amount which causes the expected incremented value produced by the provider sequencer 176 and the app-sequenced incremented value produced by the app sequencer 172 to always be the same; and, if the app-sequenced incremented value and the expected incremented value are different, this indicates a potentially counterfeit, fraudulent, or incorrect request, causing the request to be denied in item 108. Similarly, if any of the information supplied by the app and maintained by the provider device to the decision-making process in item 108 is different or inconsistent, this causes the data to be invalidated in item 108 and the user's request to be denied in item 110.

In greater detail, items that can be compared in item 108 include the unique app identifier, the device's hardware information, the user's identification information, the incremented values, etc. Further, each piece of information can be compared individually, or such individual pieces of information can be used in a methodology that produces resulting values (e.g., numeric or alphanumeric code) that can be compared. For example, all or any of the foregoing data items can be multiplied, divided by, added to, subtracted from, etc., the incremented values, constants, or other values to produce a first resulting value using the information within the request data and an expected resulting value using the information maintained within the electronic storage devices of the provider device. The first resulting value can then simply be compared with the expected resulting value to determine whether the request data is valid in item 108. Such processing is not limited to these methods of using/combining such data, and any other similar addition, combination, functional calculation, logical operations, etc., can be performed on such information/data to produce first/expected resulting values that can allow the request data to be considered valid or invalid in item 108.

As shown in item 122 in FIG. 1, the methods and systems herein add the incremented user-specific signature to the user-specific registry 104. As shown in FIG. 3, this incremented user-specific signature is generated by the provider in item 178.

Also, the determination of whether the request data is valid in item 108 can be based on a comparison of user-specific signatures (one calculated using the app-sequenced incremented value and the other calculated using the expected incremented value) as shown by the broken-line data arrow from item 178 to item 108 in FIG. 3. Therefore, the processing in item 178 can generate one or both of such user-specific signatures, once supplied with the app-sequenced incremented value and the expected incremented value (along with whatever information item 178 requires to formulate a user-specific signature).

Specifically, the processing in item 178 receives/retrieves the expected incremented value from the provider sequencer 176 and potentially the immediately previous (e.g., most recently entered or last entered) user-specific signature maintained within the user-specific registry 104. The processing in item 178 then generates the incremented user-specific signature using the sequenced/expected incremented value, at least some of the request information, possibly other elements within the request data, possibly time/date, etc., (using, for example, algorithms, combination processing, etc.).

In other examples, the provider sequencer 176 can be omitted and instead the user-specific registry 104 can include a data value for a constant increment amount (which is a single, non-changing, constant value stored in the user-specific registry 104). With this in item 178 the provider device can extract the incremented value of the most immediately previous user-specific signature within the user-specific registry 104 (e.g., by performing a reverse logical operation of that used to generate the most immediately previous user-specific signature). This extracted incremented value is then incremented by the constant increment amount maintained in the user-specific registry 104 using the provider device to produce the expected incremented value.

The ways in which the incremented user-specific signature can be generated in item 178 are numerous and can include, for example, adding the expected incremented value as a numerical extension of the most previous user-specific signature in the user-specific registry 104. Further, a new incremented user-specific signature can be generated by performing a logical operation (multiplication, division, addition, subtraction, etc.) using the expected incremented value and any information from the request data, such as unique app identifier, the device's hardware information, the user's identification information, the incremented values, etc.; or such information can simply be used to update the most recent user-specific signature within the user-specific registry 104 to generate the next incremented user-specific signature. In any case, all such processing includes at least the following in each user-specific signature: data that identifies the user, data of the user request, data of the incremented value. Such processes are only examples and not limitations, and the creation of the incremented user-specific signature 178 is intended to include all similar processes.

The following oversimplified example illustrates some aspects of the foregoing processing shown in FIGS. 1-3. A user who is named U1 may have a user device with a unique serial number D1 operating a provider app with unique serial number A1 after the app has been allowed in item 150. The provider app may use a first (initial, starting) incremented value of 3 to create the following initial user-specific signature: U1D1A13 in item 102.

Continuing with this example, the user may provide the very first request information of a payment of $10 to a merchant named M1 through the app in item 106. The app sequencer 172 may increment by an amount of 5 (starting with an initial synchronized value of 3 per item 152). With this, the app may generate the following oversimplified request data: U1D1A1_M1$10P8 (where “P” represents payment and the app-sequenced incremented value is 5+3=8) in item 170.

When determining the validity of the request data in item 108, the provider device may verify that the correct user, device and app are present (U1D1A1) and the provider device may decode the “8” in the request data (last digit: U1D1A1_M1$10P8) as the app-sequenced incremented value and may verify this value as matching the expected incremented value (8) generated by the identically incremented provider sequencer 176. Alternatively, if the user-specific registry 104 maintains a constant increment amount of 5, the provider device may add the constant increment amount 5 to the initial incremented value of 3 within the initial user-specific signature (U1D1A13) maintained in the user-specific registry 104 to arrive at the expected incremented value of 8.

Because the app-sequenced incremented value (8) matches the expected incremented value (8) and the correct user, device and app are present, in item 108 this will cause request approval 112 and cause the request to be processed 114. In this example, processing occurs by having funds ($10) paid (P) to the merchant M1 in item 118.

In item 178 the provider may generate an incremented user-specific signature by merely combining (again, oversimplified) the initial user-specific signature (U1D1A13) with the request data (M1$10P). Specifically, such a combination may remove the app-sequenced incremented value (8) from the request data, may add an indicator of whether the request was granted (e.g., yes (Y)), and may update the user-specific signature by the incremented value. Therefore, in this oversimplified example, the incremented user-specific signature could be generated in item 178 as follows: U1D1A18-M1$10PY, and this may be stored as the very last entry in the user specific registry 104 in item 122.

While the previous example is oversimplified, the length and amount of data contained within the user-specific electronic can vary depending upon the transaction type. For example, if the user-specific signature is for a bank withdrawal and the user-specific signature will only be maintained by the bank, a small amount of information can be encoded in the user-specific signature, such as account number, time stamp, withdrawal amount, user name, etc. In contrast, if the user-specific signature documents user assent to a transaction with a third party, in addition to the foregoing data, the user-specific signature can encode the third party's name, location, account number, etc. Further, for more significant transactions, even more data can be encoded in the user-specific signature, such as: a legal description of real estate being purchased, a description of all (or at least significant) contractual terms, a description of specifics of the item being purchased (e.g., model number/name, serial number, color, size, etc.).

One aspect of methods and systems herein is that each incremented user-specific signature can be generated in item 178 to include information that allows the history of each user request to be uncovered. Specifically, each incremented user-specific signature can include at least an identification of the user, their request, their device, and an order in which the requests were processed. In other words, the user-specific signature is not specific just to the user, but is also specific to the device, app, request, etc. Therefore, the provider organization can review any entry within the user-specific registry 104 to obtain details surrounding a specific request, how the request was processed, which user, device, and app made the request, the incremented value that was used to approve or deny the request, etc., allowing quick and simplified forensics and other future analysis.

Further, by basing the user-specific signature on sources that contain dynamic data, each user-specific signature is unique from all other user-specific signatures, even if the same method (e.g., same cipher and key) is used to combine the data into the user-specific signature. In other words, because each user request is different (different merchant/asset, different time/day stamp, different physical location, different financial amount, etc.) and because the sequencers always produce incremented values relative to previously generated data, each user-specific signature will be unique relative to all other user-specific signatures.

Another feature that reduces the likelihood of nefarious duplication of such user-specific electronic signatures is that methods and systems herein limit part of the data used to create legitimate user-specific electronic signatures to data that is only known by the financial institution. Therefore, the user-specific electronic signatures are calculated using two-part data, one part of which is only maintained by the financial institution and one part of which is associated with the user request. For example, one number of such two-part data can be a transaction amount (a withdrawal amount, a purchase amount, a deposit amount, etc.), which is part of the user request, and another number of such two-part data can be post-transaction user account balance, such as an ending balance of a user's account after deposit (such as a savings or checking account balance after a withdrawal), a remaining credit limit amount after a credit charge, a loan balance remaining after a payment, etc.

Further, while the user-specific signature is described as an alphanumeric code or encryption stream, the user-specific electronic signature can be created using other elements also, such as graphic elements including images, glyphs, barcodes, simulated handwriting, etc. As is understood, all graphic such items can be converted back into the alphanumeric code or encryption stream by reversing the process used to convert such to the graphic item. Therefore, the data within the user-specific signature can be stored as, or converted, to bitmaps allowing the user-specific signatures to be visually represented on a display screen or printed on print media. Because the data within each user-specific signature is unique, each bitmap representation of such data is similarly unique.

This processing repeats for all subsequent user requests as shown by the processing flow arrow returning from item 122 back to item 106 in FIG. 1. Therefore, for the next and all subsequent user requests, in these methods the app (operating on the user device) receives subsequent request information 106 (that follows the previous “request information” discussed above). To repeat the above-described processing, in these methods the app automatically adds a subsequent app-sequenced incremented value to the subsequent request information to produce subsequent request data 170, and automatically sends the subsequent request data to the provider device over the computerized network 174.

Similar to that described above, when repeating this processing the provider device obtains a subsequent expected incremented value from the provider sequencer 176 or automatically calculates the subsequent expected incremented value by adding a constant increment amount to the incremented value within the last stored user-specific signature within the user-specific registry, automatically determines the validity of the subsequent request data by comparing at least the subsequent app-sequenced incremented value with the subsequent expected incremented value 108, automatically processes the subsequent request information if the subsequent request data is valid 114, automatically creates a subsequent incremented user-specific signature that incorporates the user information and the subsequent app-sequenced incremented value 178, and automatically adds the subsequent incremented user-specific signature to the user-specific registry 122.

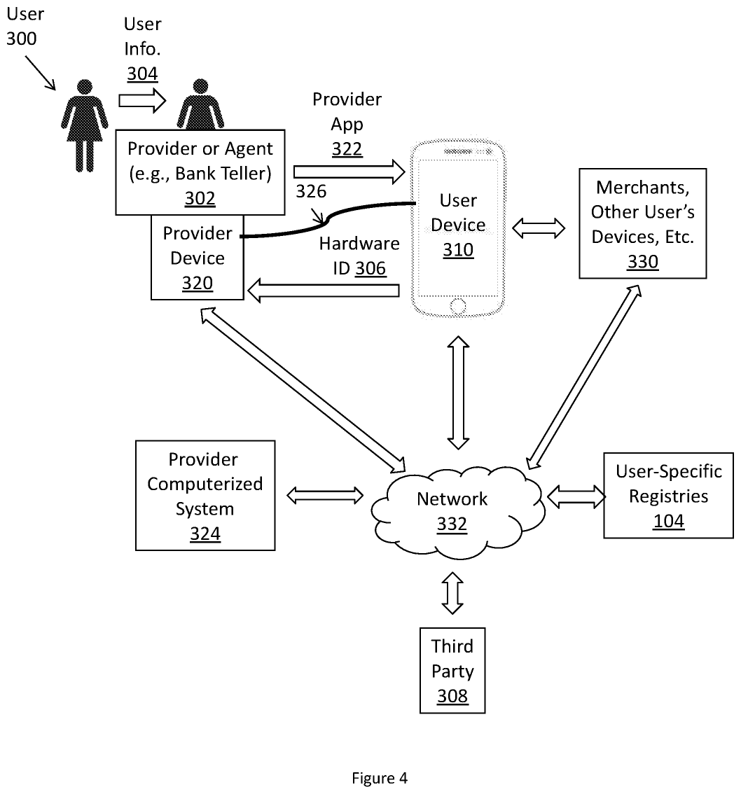

FIG. 4 illustrates some aspects of a non-limiting example of systems herein that include (among other components) a provider device 320, a provider app 322, and a provider computerized system 324 that is operatively connected to the provider device 320 through a computerized network 332. As shown in FIG. 4, in order to verify the identity of the user 300, the provider/agent 302 obtains what is referred to herein as physically supplied user information 304 of the user 300. As noted above, a human representative of the provider/agent 302 can obtain a government issued identification and a signature from the user 300 when physically meeting with the user 300. For example, a bank employee can check the driver's license, passport, etc., of a new or existing user and have the user provide an authorized signature (or such could have been done historically and maintained by the bank in a repository of signature cards).

The provider device 320 is operated by the provider/agent 302 and used by the provider/agent 302 to input the physically supplied user information 304 by scanning and/or manual input (e.g., keystrokes, menu selections, etc.). Such physically supplied user information is transmitted from the provider device 320 to the provider computerized system 324 where it is stored for future use.

The user 300 possesses one or more user devices 310 that are considered herein to be “associated with” the user 300 because such devices 310 are in the user's 300 possession. After the identity of the user 300 is verified by the provider/agent 302, the provider/agent 302 potentially verifies the user device 310 and supplies the provider app 322 to the user device(s) 310.

Either at the same time that the user's 300 identity is verified or at a later time, the initially obtained hardware identifiers 306 of the user device 310 are obtained. For example, in one option, the provider/agent 302 (when physically or virtually meeting with the user 300) can connect the provider device 320 to the one or more user-supplied devices 310. In other examples, the provider computerized system 324 can connect to the user device(s) remotely through the computerized network 332 to read the initially obtained hardware identifiers, or the initially obtained hardware identifiers can be obtained by the provider app 322 during the installation of the provider's app 322 on the user device 310.

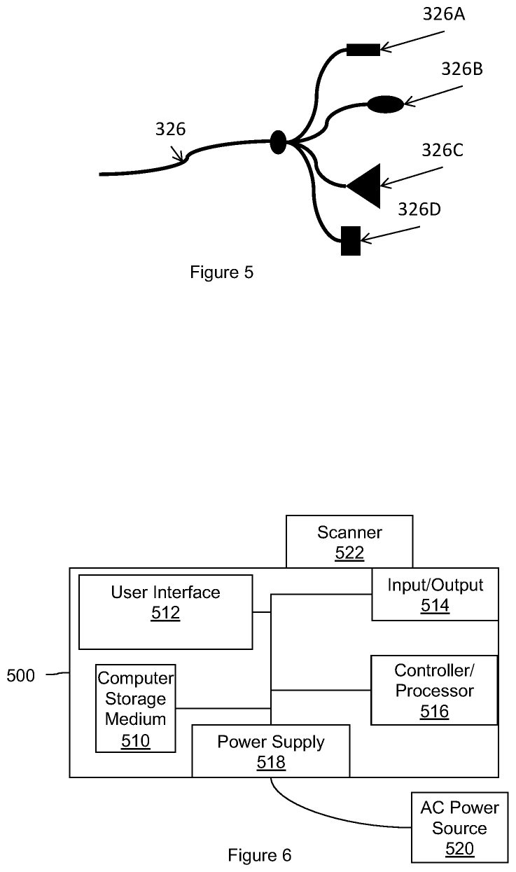

Thus, in one example the provider device 320 can include a physical attachment 326 for connecting to the user device 310. Details of the physical attachment 326 are shown in FIG. 5. More specifically, as shown in FIG. 5, the physical attachment can include a number of different style connectors 326A-326D each of which is shaped, sized, etc., to form a proper communications connection with a different type of user device 310.

If the provider device 320 is connected to the user device 310 through such a physical attachment 326, the provider device 320 is adapted to obtain the initially obtained hardware identifiers 306 of the user device 310. Again, the provider device 320 is connected to the user device 310 only after the provider/agent 302 has verified the identity of user 300 using the physically supplied user information 304. The provider device 320 transmits the physically supplied user information 304, and potentially the initially obtained hardware identifiers 306 of the user device 310, to the provider computerized system 324 through the network 332.

After at least verifying the identity of the user, the provider/agent 302 physically supplies the provider app 322 to the device 310. For example, the provider device 320 (after obtaining the initially obtained hardware identifiers 306) can supply the provider app 322 while still physically connected to the user device 310 through the physical attachment 326. In other alternatives, the provider/agent 302 can supply an electronic storage media device (e.g., disk, memory stick, etc.) to the user 300 to allow the user 300 to install the provider app 322 on the user device 310, or the provider app 322 can be remotely downloaded to the user device 310 through the computerized network 332, etc. Any electronic storage media devices containing the provider app 322 supplied to users can be user-specific devices that automatically delete the provider app 322 at the very first use instance (e.g., when the provider app 322 is supplied to a device) and this prevents unauthorized copies of the provider app 322 from being supplied to other devices because the app can be taken from the electronic storage media device one time (after which it is automatically deleted). One feature of methods and systems herein is that the distribution of the provider app 322 is physically restricted to users 300 whose identity has been verified and who have potentially supplied approved devices 310.

Therefore, the methods and systems herein install the provider app 322 on the user device 310, which may require the provider agent 302 to enter a password or key (that is known only to provider agents) into the user device 310. During such installation, the initially obtained hardware identifiers 306 can be obtained from the user device 310, if they have not been previously obtained by the provider device 320. If the initially obtained hardware identifiers 306 are obtained during installation by the provider app 322, the initially obtained hardware identifiers 306 are transmitted by the provider application 322 to the provider computerized system 324 through the computerized network 332, at which point the provider computerized system 324 either approves or disapproves the user device 310 (using the criteria described above). If the user device 310 is approved, installation continues; however, if the user device 310 is disapproved, installation terminates and the provider app 322 can be adapted to automatically delete itself from the user device 310.

The provider app 322 is adapted to (if, and when, installed on the user device 310) obtain read hardware identifiers of the user device 310 and obtain entered user information through a user interface of the user device 310. The provider app 322 automatically encrypts and stores the read hardware identifiers and the entered user information as what is referred to herein as “encrypted data” in the electronic memory of the user device 310. Each different provider app 322 that is supplied to each different user device 310 contains a different encryption key for such encryption. The provider app 322 automatically transmits (or causes the user device 310 to transmit) the encrypted data to the provider computerized system 324 through the computer network 332, etc.

As an additional safeguard to prevent inappropriate or unauthorized use of the provider app 322, the provider computerized system 324 is adapted to evaluate the encrypted data and allow or deny use of the provider app 322 on the user device 310. For example, the provider computerized system 324 is adapted to evaluate the encrypted data by at least decrypting the encrypted data as decrypted data using a key consistent with the encryption methodology used by the provider app 322, determining whether the read hardware identifiers in the decrypted data match the initially obtained hardware identifiers 306, and determining whether the entered user information in the decrypted data match the physically supplied user information 304.

After use of the provider app 322 on the user device 310 has been allowed by the provider computerized system 324, the provider app 322 is adapted to create a first user-specific signature that incorporates user information, associated with a user of the user device 310, and a first incremented value; and the app 322 is adapted to receive a user request from the user 300 through the user interface of the user device 310.

The provider device 320 is adapted to store the first user-specific signature in a user-specific registry 104. The app 322 receives request information. The app 322 is adapted to add an app-sequenced incremented value to the request information to produce request data. The app 322 is adapted to send the request data to the provider device 320 over the computerized network.

The provider device 320 is adapted to calculate an expected incremented value. The provider device 320 is adapted to determine the validity of the request data by comparing at least the app-sequenced incremented value with the expected incremented value. The provider device 320 is adapted to process the request information based on the request data being valid. The provider device 320 is adapted to create an incremented user-specific signature that incorporates the user information and the app-sequenced incremented value based on the request data being valid, and the provider device 320 is adapted to add the incremented user-specific signature to the user-specific registry.

FIG. 6 illustrates some details of a computerized device 500, which can be used with systems and methods herein; and FIG. 6 illustrates some of the components of any of the devices previously described, including the user device 310, the provider device 320, a computer within the provider computerized system 324, other devices 330, a computer within the computerized network 332, etc. Therefore, the computerized device 500 can comprise, for example, a server, a personal computer, a portable computing device, a special-purpose device (e.g., provider device 320), etc.

The computerized device 500 includes a controller/tangible processor 516 and a communications port (input/output) 514 operatively connected to the tangible processor 516 and to the computerized network 332 external to the computerized device 500. Also, the computerized device 500 can include at least one user interface (UI) assembly 512, which can include a screen or display, an input surface such as a touchpad or keyboard, etc. The user may receive messages, instructions, and menu options from, and enter instructions through, the user interface or control panel 512. A scanner 522 can be included as a component of the computerized device 500 to optically scan items such as the physically supplied user information, etc.

The input/output device 514 is used for communications to and from the computerized device 500 and comprises a wired device or wireless device (of any form, whether currently known or developed in the future). The tangible processor 516 controls the various actions of the computerized device. A non-transitory, tangible, computer storage medium device 510 (which can be optical, magnetic, capacitor based, etc., and is different from a transitory signal) is readable by the tangible processor 516 and stores instructions that the tangible processor 516 executes to allow the computerized device to perform its various functions, such as those described herein. Thus, as shown in FIG. 6, a body housing has one or more functional components that operate on power supplied from an alternating current (AC) source 520 by the power supply 518. The power supply 518 can comprise a common power conversion unit, power storage element (e.g., a battery, etc.), etc.

The hardware described herein plays a significant part in permitting the foregoing method to be performed, rather than function solely as a mechanism for permitting a solution to be achieved more quickly, (i.e., through the utilization of a computer for performing calculations). Specifically, the above-described computerized hardware is required to allow the provider app to operate on the user device, to allow the provider app to read hardware identifiers of the user device, to allow the app to communicate with the provider computerized system through the network. Similarly, such hardware plays a significant part in restricting the creation of electronic signatures to the provider computerized system, such hardware allows the provider computerized system to generate the electronic signatures (which cannot be generated by humans alone), and such hardware is significant in the communications through the network performed by the provider computerized system.

As would be understood by one ordinarily skilled in the art, the processes described herein cannot be performed by a human alone (or one operating with a pen and a pad of paper) and instead such processes can only be performed by a machine (especially when the complexity of encryption, digital certificates, and electronic signatures is considered, and the speed at which such data needs to be evaluated is considered). For example, if one were to manually attempt to calculate a digital certificate or electronic signature by the methods and devices discussed herein, the manual process would be sufficiently inaccurate and take an excessive amount of time so as to render the manual results useless. Specifically, such processes require the utilization of different specialized machines, and humans performing such processing would not produce useful results because of the time lag, inconsistency, and inaccuracy humans would introduce into the results.

Further, processes such as electronic transmission of data over networks, creating/reading digital certificates, encryption processes using device, transaction, and user data, etc., requires the utilization of different specialized machines and such actions performed automatically cannot be performed manually (because it would take decades or lifetimes) and are integral with the processes performed by methods herein. Further, electronic signatures rely upon the confidence of the recipient that such an electronic signature is valid and binding, and electronic signatures produced by humans without machines would not produce the same level of confidence, destroying the value of the electronic signatures.

Also, such machine-only processes are not mere post-solution activity because the methods require the utilization of machines at each step, such as running the provider app, verifying hardware identifiers of components of the user device, creating and transmitting the electronic signature, etc., and such processing cannot be performed without machines. Also, the data transmissions are integral with the process performed by the methods herein to restrict creation of electronic signatures to the provider. Additionally, such data transmissions are not mere post-solution activity, because the methods herein rely upon the previous data receipt to perform the next processing step, and actions such as restricting creation of electronic signatures to the provider cannot be performed without such electronic transmissions. In other words, these various machines are integral with the methods herein because the methods cannot be performed without the machines (and cannot be performed by humans alone).

Additionally, the methods herein solve many highly complex technological problems. For example, as mentioned above, electronic signatures suffer from the technological problems of not being secure enough, or of being overly technically complex to create and use (if they do have strong security). Such technological problems place barriers in the way of using electronic signatures by reducing confidence that the electronic signature is valid (caused by the technological problem of low security electronic signatures) or making it very difficult to create higher security electronic signatures (caused by the technological problem of over-complexity of higher security electronic signatures).

Methods herein solve these technological problem by reducing the technical complexity of creating and using high-security electronic signature and by restricting creation/storage of such signatures to the provider. As explained above, the methods and systems herein reduce the number of in-person meetings between providers and their users by using historically maintained identity verifications, reduce technological complexity by limiting user interaction to a request through an app, increase security with the electronic signature being generated and processed by the provider (after verifying that the app and user device are valid), etc. By changing the technology to create and process electronic signatures at the provider computerized system and including technology in the provider app that limits the user and the user device to making requests through the app, the revised technology of the methods and systems disclosed herein simplify the creation of the electronic signature for the user (reducing barriers to electronic signature creation) yet still output a high-security electronic signature (reducing barriers to acceptance of electronic signatures).

Also, as mentioned above, the methods and devices herein greatly simplify the operation from the user's viewpoint by reducing the number of interactions with the user interface (user interaction reduced to a user request), which decreases the amount of time needed to perform the operations described herein, etc. This, in turn, reduces the amount of time that the user interface is on (thereby saving power) and also reduces the load on all processing components (e.g., reduces load on the user interface equipment by avoiding a complicated user-created electronic signature operation, which in turn reduces load on the processor, by avoiding calculating the estimated dimensions, etc.). Thus, the methods herein reduce the amount and complexity of hardware and software needed to be purchased, installed, and maintained, by the user thereby solving a substantial technological problem that providers experience today.

While some exemplary structures are illustrated in the attached drawings, those ordinarily skilled in the art would understand that the drawings are simplified schematic illustrations and that the claims presented below encompass many more features that are not illustrated (or potentially many less) but that are commonly utilized with such devices and systems. Therefore, Applicants do not intend for the claims presented below to be limited by the attached drawings, but instead the attached drawings are merely provided to illustrate a few ways in which the claimed features can be implemented.

Many computerized devices are discussed above. Computerized devices that include chip-based central processing units (CPU's), input/output devices (including graphic user interfaces (GUI), memories, comparators, tangible processors, etc.) are well-known and readily available devices produced by manufacturers such as Dell Computers, Round Rock Tex., USA and Apple Computer Co., Cupertino Calif., USA. Such computerized devices commonly include input/output devices, power supplies, tangible processors, electronic storage memories, wiring, etc., the details of which are omitted herefrom to allow the reader to focus on the salient aspects of the systems and methods described herein. Similarly, scanners and other similar peripheral equipment are available from Xerox Corporation, Norwalk, Conn., USA and the details of such devices are not discussed herein for purposes of brevity and reader focus.

Further, the terms automated or automatically mean that once a process is started (by a machine or a user), one or more machines perform the process without further input from any user. In the drawings herein, the same identification numeral identifies the same or similar item.

It will be appreciated that the above-disclosed and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims. Unless specifically defined in a specific claim itself, steps or components of the systems and methods herein cannot be implied or imported from any above example as limitations to any particular order, number, position, size, shape, angle, color, or material.

What is claimed is:

1. A method comprising:
providing, by a provider device, an app to a user device;
creating, by the provider device, a first user-specific signature that incorporates user information, associated with a user of the user device, and a first incremented value;
storing, by the provider device, the first user-specific signature in a user-specific registry;
receiving, by the app, request information;
adding, by the app, an app-sequenced incremented value to the request information to produce request data;
sending, by the app, the request data to the provider device over a computerized network;
calculating, by the provider device, an expected incremented value;
determining, by the provider device, validity of the request data by comparing at least the app-sequenced incremented value with the expected incremented value;
processing, by the provider device, the request information based on the request data being valid;
creating, by the provider device, an incremented user-specific signature that incorporates the user information and the app-sequenced incremented value based on the request data being valid; and
adding, by the provider device, the incremented user-specific signature to the user-specific registry.

2. The method according to claim 1, further comprising maintaining, by the app and the provider device, identically incremented sequencers, wherein the identically incremented sequencers are used to calculate the app-sequenced incremented value and the expected incremented value.

3. The method according to claim 1, wherein the user-specific registry and the user-specific signature are unique to a single user associated with the user device.

4. The method according to claim 1, further comprising creating, by the app, a request-based user-specific signature that incorporates at least portions of the user information and the app-sequenced incremented value.

5. The method according to claim 4, further comprising adding, by the app, the request-based user-specific signature to the request information when producing the request data.

6. The method according to claim 1, further comprising adding, by the app, at least one of app information of the app and user device hardware information of the user device to the request information when producing the request data.

7. The method according to claim 1, further comprising:
receiving, by the app, subsequent request information that follows the request information;
adding, by the app, a subsequent app-sequenced incremented value to the subsequent request information to produce subsequent request data;
sending, by the app, the subsequent request data to the provider device over the computerized network;
calculating, by the provider device, a subsequent expected incremented value;
determining, by the provider device, validity of the subsequent request data by comparing at least the subsequent app-sequenced incremented value with the subsequent expected incremented value;
processing, by the provider device, the subsequent request information based on the subsequent request data being valid;
creating, by the provider device, a subsequent incremented user-specific signature that incorporates the user information and the subsequent app-sequenced incremented value based on the subsequent request data being valid; and
adding, by the provider device, the subsequent incremented user-specific signature to the user-specific registry.

8. A method comprising:
registering a user device with a provider device by an agent associated with the provider device physically verifying an identify of a user of the user device;
providing, by the provider device, an app to the user device;
automatically generating, by a provider sequencer of the provider device, a first incremented value using a provider sequencer of the provider device;
automatically creating, by the provider device, a first user-specific signature by combining at least portions of user information and the first incremented value into a string of values comprising the first user-specific signature;
automatically storing, by the provider device, the first user-specific signature in a user-specific registry maintained only in storage of the provider device, wherein a different user-specific registry is maintained for each different user device registered with the provider device;
receiving, by the app operating on the user device, request information associated with a request of the user;
automatically generating, by the app operating on the user device, an app-sequenced incremented value using an app sequencer of the app;
automatically adding, by the app operating on the user device, the app-sequenced incremented value to the request information to produce request data;
automatically sending, by the app operating on the user device, the request data to the provider device over a computerized network;
automatically calculating, by the provider device, an expected incremented value;
automatically determining, by the provider device, validity of the request data by comparing at least the app-sequenced incremented value with the expected incremented value;
automatically outputting, by the provider device, approval of the request of the user based on the request data being valid, wherein approval of the request of the user causes the request to be processed;
automatically creating, by the provider device, an incremented user-specific signature that incorporates the user information and the app-sequenced incremented value based on the request data being valid; and
automatically adding, by the provider device, the incremented user-specific signature to the user-specific registry immediately following the first user-specific signature in the user-specific registry.

9. The method according to claim 8, further comprising maintaining, by the app and the provider device, identically incremented sequencers, wherein the identically incremented sequencers are used to calculate the app-sequenced incremented value and the expected incremented value.

10. The method according to claim 8, wherein the user-specific registry and the user-specific signature are unique to a single user associated with the user device.

11. The method according to claim 8, further comprising automatically creating, by the app operating on the user device, a request-based user-specific signature that incorporates at least portions of the user information and the app-sequenced incremented value.

12. The method according to claim 11, further comprising automatically adding, by the app operating on the user device, the request-based user-specific signature to the request information when producing the request data.

13. The method according to claim 8, further comprising automatically adding, by the app operating on the user device, at least one of app information of the app and user device hardware information of the user device to the request information when producing the request data.

14. The method according to claim 8, further comprising:
receiving, by the app operating on the user device, subsequent request information that follows the request information;
automatically adding, by the app operating on the user device, a subsequent app-sequenced incremented value to the subsequent request information to produce subsequent request data;
automatically sending, by the app operating on the user device, the subsequent request data to the provider device over the computerized network;
automatically calculating, by the provider device, a subsequent expected incremented value;
automatically determining, by the provider device, validity of the subsequent request data by comparing at least the subsequent app-sequenced incremented value with the subsequent expected incremented value;
automatically processing, by the provider device, the subsequent request information based on the subsequent request data being valid;
automatically creating, by the provider device, a subsequent incremented user-specific signature that incorporates the user information and the subsequent app-sequenced incremented value based on the subsequent request data being valid; and
automatically adding, by the provider device, the subsequent incremented user-specific signature to the user-specific registry.

15. A system comprising:
a provider device; and
an app operatively connected to the provider device through a computerized network,
wherein the provider device is adapted to provide the app to a user device,
wherein the provider device is adapted to create a first user-specific signature that incorporates user information, associated with a user of the user device, and a first incremented value,
wherein the provider device is adapted to store the first user-specific signature in a user-specific registry,
wherein the app is adapted to receive request information,
wherein the app is adapted to add an app-sequenced incremented value to the request information to produce request data,
wherein the app is adapted to send the request data to the provider device over the computerized network,
wherein the provider device is adapted to calculate an expected incremented value,
wherein the provider device is adapted to determine validity of the request data by comparing at least the app-sequenced incremented value with the expected incremented value,
wherein the provider device is adapted to process the request information based on the request data being valid,
wherein the provider device is adapted to create an incremented user-specific signature that incorporates the user information and the app-sequenced incremented value based on the request data being valid, and
wherein the provider device is adapted to add the incremented user-specific signature to the user-specific registry.

16. The system according to claim 15, further comprising identically incremented sequencers within the app and the provider device, wherein the identically incremented sequencers are used to calculate the app-sequenced incremented value and the expected incremented value.

17. The system according to claim 15, wherein the user-specific registry and the user-specific signature are unique to a single user associated with the user device.

18. The system according to claim 15, wherein the app is adapted to create a request-based user-specific signature that incorporates at least portions of the user information and the app-sequenced incremented value.

19. The system according to claim 18, wherein the app is adapted to add the request-based user-specific signature to the request information when producing the request data.

20. The system according to claim 15, wherein the app is adapted to add at least one of app information of the app and user device hardware information of the user device to the request information when producing the request data.
